(19) United States
(12) Patent Application Publication
(10) Pub. No.: US 2006/0082521 A1
(43) Pub. Date: Apr. 20, 2006

(54) Display device and driving method thereof

(76) Inventors: Seung-Rok Shin, Suwon-si (KR); Gab-Sick Kim, Suwon-si (KR); Hak-Cheol Yang, Suwon-si (KR)

Correspondence Address: H.C. PARK & ASSOCIATES, PLC, 8500 LEESBURG PIKE, SUITE 7500, VIENNA, VA, 22182, US

(21) Appl. No.: 11/183,743

(22) Filed: Jul. 19, 2005

(30) Foreign Application Priority Data
Oct. 19, 2004 (KR) 10-2004-0083569

(51) Int. Cl. G09G 3/28

(52) U.S. Cl. 345/63

(57) ABSTRACT

In a display device, one field is divided into two groups of subfields. Light-emitting cells are selected by a selective write process in a first group of subfields and a gray scale is represented by a combination of weights of subfields. Light-emitting cells are selected by the selective write process in a first subfield of a second group of subfields, and non-light-emitting cells are selected from the light-emitting cells by a selective erase process in the remaining subfields of the second group of subfields. In the second group of subfields, a gray scale is represented by the sum of weights of subfields from when the light-emitting cell is selected in the first subfield to when the non-light-emitting cell is selected. In this manner, a gray scale of one field may be represented by a combination of the first and second groups of subfields.

### CROSS REFERENCE TO RELATED APPLICATION

This application claims priority to and the benefit of Korea Patent Application No. 10-2004-0083569, filed on Oct. 19, 2004, which is hereby incorporated by reference for all purposes as if fully set forth herein.

### BACKGROUND OF THE INVENTION

1. Field of the Invention

The present invention relates to a display device and a driving method thereof, and more particularly, to a driving method for representing gray scales using subfields.

2. Discussion of the Background

Generally, in a display device such as a plasma display, one field (1TV field) is divided into a plurality of subfields, and each subfield has an assigned weight. Gray scales are represented by combining weights of active (i.e., displayed) subfields of the plurality of subfields. Each subfield typically includes an address period, during which discharge cells to be lit are selected, and a sustain period, during which the selected discharge cells are sustain discharged during a period corresponding to the subfield's weight.

An address display separation (ADS) driving method includes performing a sustain discharge operation for all discharge cells after addressing all discharge cells in each subfield. In other words, the address period is separate from the sustain period. The ADS method can be easily implemented, but since the addressing operation is sequentially performed for all discharge cells, some discharge cells to be addressed in the latter stages of the address period may not actually get addressed due to lack of priming particles within the discharge cells. Therefore, to secure a stable addressing operation, the width of scan pulses sequentially applied to row electrodes may be increased, but this lengthens the address period. Consequently, the subfields also become longer, which limits the number of subfields available in one field.

Unlike the ADS method, an address while display (AWD) driving method includes inserting an address pulse for each line between two successive sustain discharge pulses and performing the addressing operation for one line while performing the sustain discharge operation for another line. Hence, with this method, the address period is not separate from the sustain period.

In the AWD method, a relatively lengthy reset pulse is inserted between an address pulse and a sustain discharge pulse. In other words, a strong reset discharge may cause a black screen to be seen brightly, thereby deteriorating contrast ratio.

Additionally, both the ADS method and the AWD method may use different weighted subfields to represent gray scales. For example, with subfields having weights of a type of the second power of 2, a so-called false contour may be produced when one discharge cell represents a 127^{th} gray scale level in one frame and a 128^{th} gray scale level in a following frame.

### SUMMARY OF THE INVENTION

The present invention provides a driving method of a display device, which is capable of performing a high speed scan operation.

The present invention also provides a driving method of a display device, which is capable of reducing false contour.

The present invention also provides a driving method of a display device, which is capable of improving contrast ratio.

The present invention also provides a driving method of grouping a plurality of subfields into groups of subfields for setting light-emitting cells through write discharge and groups of subfields for setting non-light-emitting cells through erase discharge after setting the light-emitting cells through the write discharge.

Additional features of the invention will be set forth in the description which follows, and in part will be apparent from the description, or may be learned by practice of the invention.

The present invention discloses a driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes. The plurality of row electrodes is grouped into a plurality of row groups, each subfield is divided into a plurality of select periods respectively corresponding to the plurality of row groups, and the plurality of subfields is grouped into a plurality of subfield groups. In a select period for a first row group of a first group of subfields, light-emitting cells are selected from discharge cells of the first row group, and the light-emitting cells of the first row group are set to non-light-emitting cells after the light-emitting cells are sustain-discharged during a sustain period. In a select period for the first row group of a first subfield, which is positioned at the head in time, of a second group of subfields, light-emitting cells are selected from discharge cells of the first row group and the light-emitting cells are sustain-discharged during a sustain period. In a select period for the first row group of a second subfield of the second group of subfields, non-light-emitting cells are selected from the light-emitting cells of the first row group and remaining light-emitting cells are sustain-discharged during a sustain period.

The present invention also discloses a driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes. The plurality of subfields is grouped into a first group of subfields including a minimal weight subfield, a second group of subfields, and a third group of subfields including at least two consecutive subfields. Additionally, the plurality of row electrodes is grouped into a plurality of row groups in the third group of subfields, and the plurality of row electrodes is grouped into a number of row groups corresponding to a weight of a subfield for each subfield in the second group of subfields. In the second and third groups of subfields, each subfield is divided into a plurality of select periods respectively corresponding to the plurality of row groups. In the first group of subfield, light-emitting cells are selected in the plurality of row electrodes, and the light-emitting cells are discharged during a period corresponding to a weight of a corresponding subfield. In a select period for a first row group of the second group of subfields, light-emitting cells are selected from discharge cells of the first row group, and the light-emitting cells are discharged during a sustain period. In a select period for a second row group of a first subfield, which is positioned at the head in time, of the third group of subfields, light-emitting cells are selected from discharge cells of the second row group, and the light-emitting cells are discharged during a sustain period. In a select period for the second row group of a second subfield of the third group of subfields, non-light-emitting cells are selected from the light-emitting cells of the second row group, and remaining light-emitting cells are discharged during a sustain period.

The present invention also discloses a driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes. The plurality of row electrodes is grouped into a plurality of row groups, and the plurality of subfields is grouped into a plurality of subfield groups. In each subfield of a first group of subfields, light-emitting cells for each row group are sequentially set. In each subfield of the first group of subfields, the light-emitting cells of the each row group are set to non-light-emitting cells after the light-emitting cells are sustain-discharged during a first period between a period for setting the light-emitting cells of a row group and a period for setting light-emitting cells of a next row group. In each subfield of a second group of subfields, light-emitting cells for each row group are sequentially set. In each subfield of the second group of subfields, the light-emitting cells are sustain-discharged during a Is second period between a period for setting the light-emitting cells of a row group and a period for setting light-emitting cells of a next row group.

The present invention also discloses a driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes. In each subfield of a first group of subfields including a minimal weight subfield of the plurality of subfields, light-emitting cells are set in the plurality of row electrodes, and the light-emitting cells are sustain-discharged during a period corresponding to a weight of the corresponding subfield. In each subfield of a second group of subfields of the plurality of subfields, the plurality of row electrodes is grouped into a number of row groups corresponding to a weight of the corresponding subfield, and light-emitting cells for each of the row groups are sequentially set. In each subfield of the second group of subfields, the light-emitting cells are sustain-discharged during a first period between a period for setting the light-emitting cells of a row group and a period for setting light-emitting cells of a next row group. In each subfield of a third group of subfields of the plurality of subfields, the plurality of row electrodes is grouped into a plurality of row groups, and light-emitting cells for each of the row groups are sequentially set. In each subfield of the third group of subfields, the light-emitting cells are sustain-discharged during a second period between a period for setting the light-emitting cells of a row group and a period for setting light-emitting cells of a next row group.

The present invention also discloses a display device including a display panel including a plurality of row electrodes, a plurality of column electrodes intersecting the plurality of row electrodes, and a plurality of discharge cells defined by the plurality of row electrodes and the plurality of column electrodes, a driver for driving the display panel, and a controller for controlling the driver such that one field is divided into a plurality of subfields to represent a gray scale. The controller groups the plurality of subfields into a plurality of subfield groups including a first group of subfields including a minimal weight subfield and a second group of subfields including at least two consecutive subfields. In addition, the controller controls the driver to set a non-light-emitting cell to a light-emitting cell through discharge in subfields, which are positioned at the head in time, of the first and second groups of subfields. Furthermore, the controller controls the driver to set a light-emitting cell to a non-light-emitting cell through discharge in remaining subfields of the second group of subfields.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic conceptual diagram showing a plasma display device according to an exemplary embodiment of the present invention.

FIG. 2 is a schematic diagram showing a plasma display panel (PDP) driving method according to a first exemplary embodiment of the present invention.

FIG. 3 is a diagram showing a gray scale representation in the driving method of FIG. 2.

FIG. 4 is a driving waveform diagram of the plasma display device according to exemplary embodiments of the present invention.

FIG. 5 is a schematic diagram showing a PDP driving method according to a second exemplary embodiment of the present invention.

FIG. 6 is a diagram showing a gray scale representation in the driving method of FIG. 5.

FIG. 7 and FIG. 8 are schematic diagrams showing PDP driving methods according to third and fourth exemplary embodiments of the present invention, respectively.

### DETAILED DESCRIPTION

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. In the drawings, illustrations of elements having no relation with the present invention are omitted in order to prevent the subject matter of the present invention from being unclear. In the specification, the same or similar elements are denoted by the same reference numerals even though they are depicted in different drawings.

Hereinafter, a display device and a driving method thereof according to exemplary embodiments of the present invention will be described in detail with reference to the accompanying drawings. A plasma display will be exemplified and described in the exemplary embodiments.

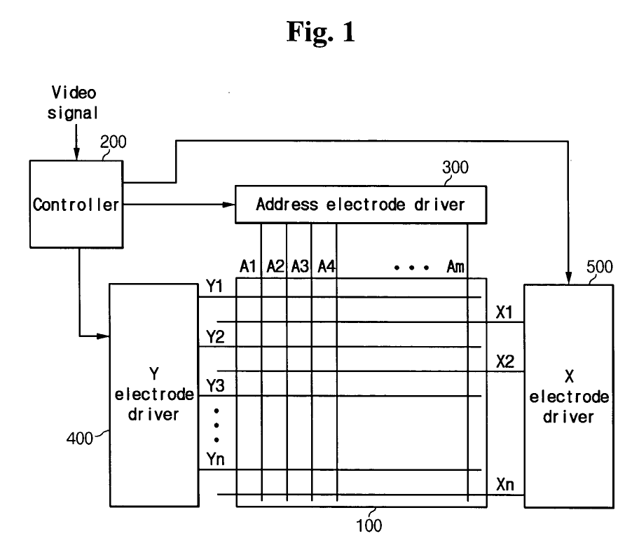

FIG. 1 is a schematic conceptual diagram showing a plasma display device according to an exemplary embodiment of the present invention.

As FIG. 1 shows, a plasma display device according to an exemplary embodiment of the present invention includes a plasma display panel (PDP) 100, a controller 200, an address electrode driver 300, a scan electrode (Y electrode) driver 400, and a sustain electrode (X electrode) driver 500.

The PDP 100 includes a plurality of address electrodes (A electrodes) A1 to Am extending in a column direction, and a plurality of X electrodes X1 to Xn and a plurality of Y electrodes Y1 to Yn, which extend in a row direction and are paired. Generally, the X electrodes X1 to Xn are formed corresponding to the Y electrodes Y1 to Yn. The A electrodes A1 to Am are arranged substantially perpendicular to the Y electrodes Y1 to Yn and the X electrodes X1 to Xn. Here, a discharge space at an intersection of an A electrode and an X and Y electrode pair forms a discharge cell. Embodiments of the present invention may be applied to PDPs having other structures.

In the following description, one discharge cell is defined by a pair of X and Y electrodes and one A electrode. Additionally, a pair of X and Y electrodes, which extend in the row direction, is referred to as the row electrode, and the A electrode, which extends in the column direction, is referred to as the column electrode.

The controller 200 receives a video signal, outputs driving control signals, divides one field into a plurality of subfields and drives the plurality of subfields. The A, Y and X electrode drivers 300, 400 and 500 apply driving voltages to the A electrodes A1 to Am, the Y electrodes Y1 to Yn, and the X electrodes X1 to Xn, respectively.

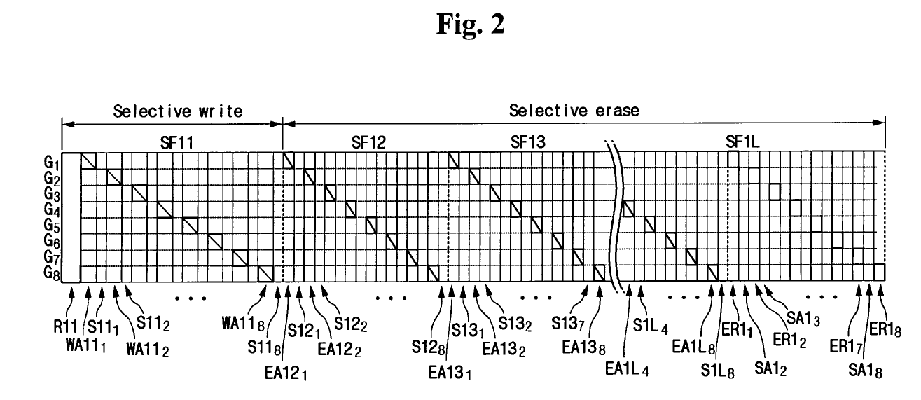

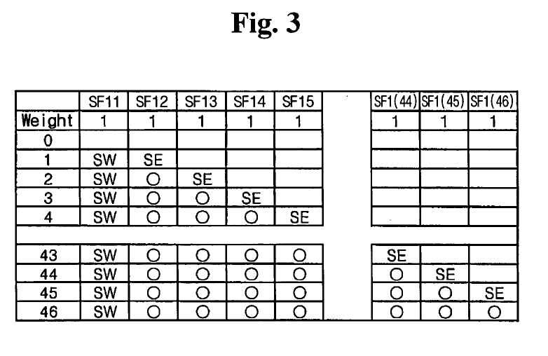

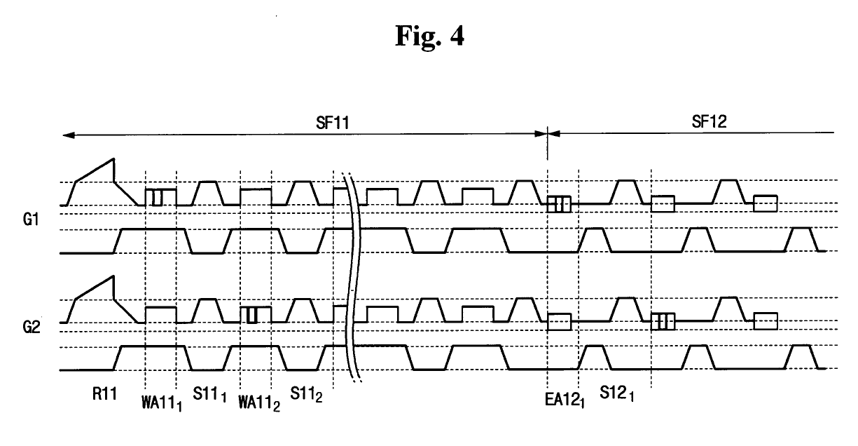

Next, a PDP driving method according to a first exemplary embodiment of the present invention will be described with reference to FIG. 2, FIG. 3 and FIG. 4. In the first exemplary embodiment of the present invention, it is assumed that the length of sustain periods following address periods of each row group are equal and that these sustain periods have the same length in all subfields.

FIG. 2 is a schematic diagram showing a PDP driving method according to a first exemplary embodiment of the present invention, and FIG. 3 is a diagram showing a gray scale representation in the driving method of FIG. 2.

As FIG. 2 shows, it is assumed that one TV field is divided into a plurality of equally weighted subfields SF11 to SF1L. Additionally, a plurality of row electrodes X1 to Xn and Y1 to Yn are divided into a plurality of row groups. For example, FIG. 2 shows 8 row groups G₁ to G₈ for convenience of explanation. That is, first to j^{th} row electrodes are set as a first row group G₁, (j+1)^{th} to (2j)^{th} row electrodes are set as a second row group G₂, and, in this way, (7j+1)^{th} to n^{th} row electrodes are set as an eighth row group G₈ (where j=n/8).

Generally, a subfield includes an address period during which discharge cells to be lit and discharge cells not to be lit are selected from a plurality of discharge cells formed in the PDP 100 and a sustain period during which a sustain discharge operation, i.e., a display operation, is performed in a selected discharge cell during a period corresponding to a weight of a subfield. Here, sustain discharge occurs when the sum of a wall voltage set between the X electrode and the Y electrode in the address period and a voltage applied between the X electrode and the Y electrode in the sustain period exceeds a discharge start voltage. The voltage applied between the X and Y electrodes in the sustain period is less than the discharge start voltage.

Processes of selecting the light-emitting discharge cells and the non-light-emitting discharge cells in the address period include a selective write process and a selective erase process. The selective write process selects light-emitting discharge cells and forms a wall voltage on the selected light-emitting discharge cells. The selective erase process selects the non-light-emitting discharge cells by erasing a wall voltage, which was formed on the non-light-emitting discharge cell. In the following description, a state where a light-emitting discharge cell is selected in the address period by the selective write process or not selected by the selective erase process is referred to as “a light-emitting cell state”, and a state where a non-light-emitting discharge cell is not selected in the address period by the selective write process or is selected in the selective erase process is referred to as “a non-light-emitting cell state.” Here, erase, erased, and erasing do not necessarily require removal of all traces of the thing being erased.

In the first exemplary embodiment of the present invention, in an address period of a first subfield SF11, a discharge cell in the non-light-emitting state is set to the light-emitting cell state by write-discharging the discharge cell to form wall charges on the discharge cell. In other words, the selective write process is performed to select the discharge cell to be turned on. In address periods of the subfields SF12 to SF1L, a discharge cell in the non-light-emitting state is set to the non-light-emitting cell state by erase-discharging the discharge cell to erase wall charges from the discharge cell. In other words, the selective erase process is performed to select a cell to be turned off. Additionally, the address periods are sequentially performed for the plurality of row groups G₁ to G₈ in the plurality of subfields SF11 to SF1L, and sustain periods having the same length are performed between the address periods. In the following description, the sum of an address period and a sustain period for one row group in each subfield is referred to as “a select period” of the row group, and the sum of sustain periods of all row groups in each subfield is referred to as “a display period” of the subfield. If the plurality of row electrodes consists of 8 row groups G₁ to G₈ as shown in FIG. 2, the display period is 8 times the sustain period in the select period of one row group.

Next, the driving method according to the first exemplary embodiment of the present invention will be described in detail with reference to FIG. 2.

To start, all discharge cells are initialized to prevent discharge cells not selected in the first subfield SF11 from being erroneously discharged in the sustain period and to accurately perform the selective write process in the address period so that discharge cells to be lit are selected. Accordingly, the first subfield SF11 has a reset period R11 during which the discharge cells of all row groups G₁ to G₈ are initialized to be non-light-emitting cells and are set to a state where the selective write operation may be successfully performed in the address period.

Select periods for the first to eighth row groups G₁ to G₈ are then sequentially performed in the first subfield SF11. Light-emitting cells of the discharge cells of an ith row group Gᵢ are selected by write-discharging the cells in an address period WA11ᵢ of the select period for the i^{th} row group. A sustain discharge occurs in discharge cells of the light-emitting cell state of the i^{th} row group Gᵢ, in a sustain period S11ᵢ of the select period for the i^{th} row group Gᵢ. At this time, the sustain discharge also occurs in discharge cells set to the light emitting cell state in each address period WA11ᵢ for the first to (i−1)^{th} row groups G₁ to Gᵢ₋₁. Additionally, the discharge cells of the i^{th} row group Gᵢ set to the light-emitting cell state in the first subfield SF11 are sustain-discharged during sustain periods S11ᵢ to S11₈ and S12₁ to S12ᵢ₋₁ of each row group until the following select period for the ith row group G1 of the second subfield SF12, i.e., during the display period.

Next, the select periods of the first to eighth row group G₁ to G₈ are sequentially performed in the second subfield SF12. Non-light-emitting cells of the discharge cells that were previously set to the light emitting cell state in the first subfield SF11 through the write discharge are selected in an address period EA12ᵢ of the select period for the i^{th} row group Gᵢ through the erase discharge. In the sustain period S12ᵢ of the select period for the ith row group Gᵢ, sustain discharge occurs for discharge cells of the light-emitting cell state (i.e., discharge cells not selected by the erase discharge that were previously selected as the light-emitting cells in the first subfield SF11). At this time, the sustain discharge also occurs in discharge cells, which are set to the light-emitting cell state in the second subfield SF12, of the discharge cells of the first to (i−1)^{th} row groups G₁ to Gᵢ₋₁ and discharge cells, which are set to the light-emitting cell state in the first subfield SF11, of the discharge cells of the (i+1)^{th} to eighth row groups Gᵢ₊₁ to G₈. Additionally, the discharge cells set to the light-emitting cell state in the i^{th} row group Gᵢ are sustain-discharged until the following select period of the i^{th} row group Gᵢ of the third subfield SF13, i.e., during the display period (S12ᵢ to S12₈ and S13₁ to S13ᵢ₋₁).

In this way, the address period of the selective erase process and the sustain period are also sequentially performed for the first to eighth row groups G₁ to G₈ in the third to last subfields SF13 to SF1L. Additionally, the discharge cells, which are set to the light-emitting cell state through the write-discharge in the first subfield SF11, of the discharge cells of the i^{th} row group Gᵢ, are sustain-discharged during the display period of each subfield until they are set to the non-light-emitting cell state through the erase discharge in an address period EA12ᵢ to EA1Lᵢ of the subsequent subfields SF12 to SF1L. Then, when a discharge cell is set to the non-light-emitting cell state, the discharge cell is no longer sustain discharged from the corresponding subfield in which it was set to the non-light-emitting cell state until at least the next TV field.

Referring to FIG. 2 again, erase periods ER1₁ to ER1₈ are sequentially performed for the row groups G₁ to G₈ in the last subfield SF1L. Since the first to eighth row group G₁ to G₈ perform the sustain discharge during the display period, the last subfield SF1L includes seven additional sustain periods SA1₂ to SA1₈ for the second to eighth row groups G₂ to G₈, respectively. Without the erase periods ER1₁ to ER1₇, the sustain discharge may be performed for row groups G₁ to G₇ for more than the display period. Accordingly, in the last subfield SF1L, erase processes are sequentially performed for the row groups G₁ to G₈ after the display period ends. These erase processes may be performed for all discharge cells of a corresponding row group, unlike the selective erase process of an address period as described above. Since the reset period R11 is performed in the first subfield SF11, the last erase period ER1₈ may be omitted.

Next, a method of representing gray scales using the driving method of FIG. 2 will be described with reference to FIG. 3. In FIG. 3, “SW” represents that a discharge cell is set to the light-emitting cell state through the write discharge occurring in a corresponding subfield, and “SE” represents that a discharge cell is set to the non-light-emitting cell state through the erase discharge occurring in a corresponding subfield. Also, “◯” represents a discharge cell that maintains the light-emitting cell state in a corresponding subfield. Additionally, as described above, since the length of the display periods of all subfields is the same, a gray scale level of 1 is represented when the sustain discharge occurs in only one subfield.

First, all discharge cells are set to the non-light-emitting cell state in the reset period R11. When the non-light-emitting cell state is maintained in the address period WA11ᵢ of the first subfield SF11, a gray scale level of 0 is represented since the sustain discharge does not occur in the sustain period. Further, the sustain discharge does not occur in the subsequent subfields SF12 to SF1L.

Additionally, when the light-emitting cell state is set through the write discharge occurring in the address period WA11ᵢ of the first subfield SF11, a gray scale level of 1 can be represented since the sustain discharge occurs in the display period of the subfield SF11. Next, when the non-light-emitting cell state is set through the erase discharge occurring in the second subfield SF12, a final gray scale level of 1 is represented since the sustain discharge does not occur from the second subfield SF12 on. Further, since the light-emitting cell state remains if the erase discharge does not occur in the second subfield SF12, a gray scale level of 2 is represented because the sustain discharge also occurs in the sustain period of the second subfield SF12.

In this way, a gray scale level of (k−1) is finally represented when the discharge cells are set to the light-emitting cell state through the write discharge occurring in the first subfield SF11 and then are set to the non-light-emitting cell state through the erase discharge in the k^{th} subfield SF1k. In other words, these discharge cells are sustain-discharged in the first to (k−1)^{th} subfields SF11 to SF1(k−1).

Next, driving waveforms for use with the driving method of the plasma display according to the first exemplary embodiment of the present invention will be described in detail with reference to FIG. 4.

FIG. 4 is a driving waveform diagram of the plasma display device according to exemplary embodiments of the present invention. In FIG. 4, for convenience of explanation, only the first and second row groups G1 and G2 and the first and second subfields SF11 and SF12 are partially shown, and the A electrode is omitted. Additionally, since the driving waveform shown in FIG. 4 is a typical PDP driving waveform, detailed explanation thereof will be omitted.

As FIG. 4 shows, in the reset period R11 of the first subfield SF11, wall charges are formed in the discharge cells by reset discharge caused by gradually increasing a voltage of the Y electrodes of both row groups G₁ and G₂ while biasing the X electrodes at a ground voltage. Next, the discharge cells are initialized by erasing the wall charges formed by the reset discharge by gradually decreasing the voltage of the Y electrodes of the row groups G₁ and G₂ while biasing the X electrodes at a positive voltage.

Subsequently, while biasing the X electrodes at the positive voltage, a scan pulse (the ground voltage in FIG. 4) is sequentially applied to the Y electrodes of the first row group G₁, and, although not shown, a positive address voltage is applied to the A electrode of discharge cells to be lit of the discharge cells corresponding to the Y electrode to which the scan pulse is applied. Then, the write discharge occurs in the discharge cells to which a voltage of the scan pulse and the address voltage are applied, thereby forming wall charges on the X electrode and the Y electrode. At this time, the scan pulse is not applied to Y electrodes of the second to eighth row groups G₂ to G₈.

Next, a sustain discharge pulse is applied to the Y electrodes in order to discharge the discharge cells of the light-emitting cell state, and then, the sustain discharge pulse is applied to the X electrodes in order to discharge the discharge cells. Then, the scan pulse is sequentially applied to the Y electrodes of the second row group G₂ while applying the sustain discharge pulse to the X electrodes, thereby performing the address period of the second group G₂. Next, the sustain discharge pulse is applied to the Y and X electrodes. In this manner, the select period for the first to eighth row groups G₁ to G₈ is performed in the first subfield SF11.

In the address period EA12₁ of the second subfield SF12, a scan pulse having a negative voltage is sequentially applied to the Y electrodes of the first row group G₁, and then, a positive voltage (not shown) is applied to the A electrode of the discharge cells to be set to the non-light-emitting cell state. At this time, the narrow width of the scan pulse causes an address discharge that erases, rather than forms, wall charges. Specifically, applying a negative voltage and a positive voltage to the Y electrode and A electrode, respectively, of the discharge cells of the light-emitting cell state, which have a wall voltage formed by the sustain discharge pulse applied to the Y electrode, erases the wall charges through discharge occurring due to the wall voltage and the applied voltages, thereby resulting in a discharge cell having the non-light-emitting cell state. The sustain discharge pulse is then alternately applied to the X electrode and the Y electrode. This process is sequentially performed for the second to eighth row groups G₂ to G₈.

In this manner, in the first exemplary embodiment of the present invention, since the address periods are formed between the sustain periods of the row groups, priming particles formed in the sustain periods may be sufficiently utilized in the address periods. Hence, high speed scanning with a narrow scan pulse may be achieved. Additionally, in the address period in the selective erase process, the width of the scan pulse may be further narrowed to erase wall charges. Further, since gradually increasing and decreasing voltages are used in the reset period, a strong discharge does not occur, and since the reset period is performed once for all row groups during one field, the contrast ratio may be increased.

For example, assume that the width of the scan pulse in the selective write process is 1.5 μs, the width of the scan pulse in the selective erase process is 0.5 μs, the length of the reset period is 350 μs, and 20 sustain discharge pulses having a width of 5 μs occur in one subfield. Under these circumstances, when driving 480 row electrodes, the first subfield SF11 requires 1,170 μs (=350+1.5×480+20×5) and each of the remaining subfields SF12 to SF1L requires 340 μs (=0.5×480+20×5). Accordingly, a total of 46 subfields may be accommodated in one subfield (16.6 ms), and 47 gray scale levels (i.e. 0 to 46) may be represented. In this case, by applying a 2×2 dithering technique, 188 (=47×4) gray scale levels may be represented. Moreover, by applying a 4-bit error diffusion technique, 3,008 (=188×16) gray scale levels may be represented.

Additionally, in the first exemplary embodiment of the present invention, false contour does not occur since all subfields have the same weight and gray scales are represented by the sum of display periods of the successive subfields starting from the first subfield.

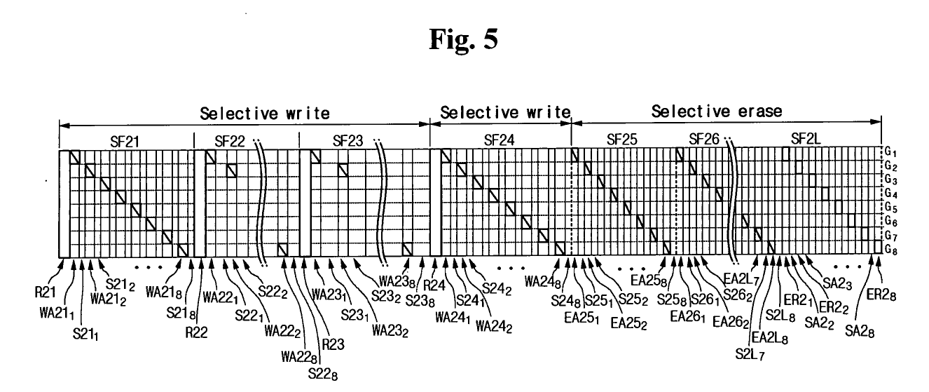

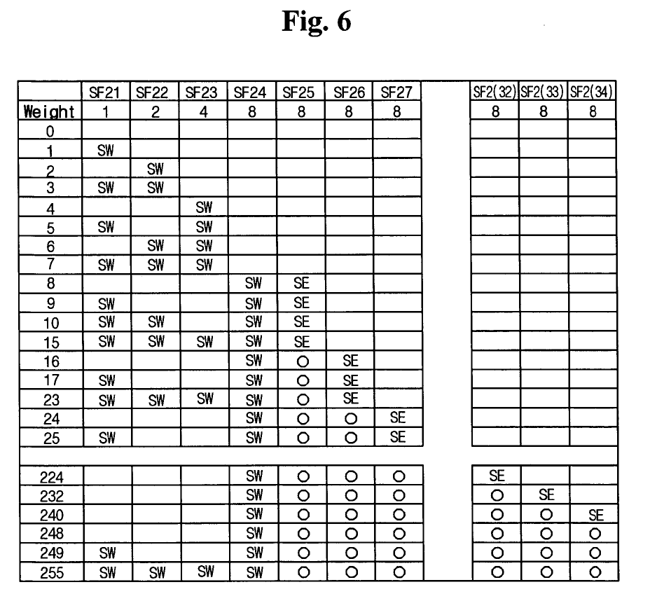

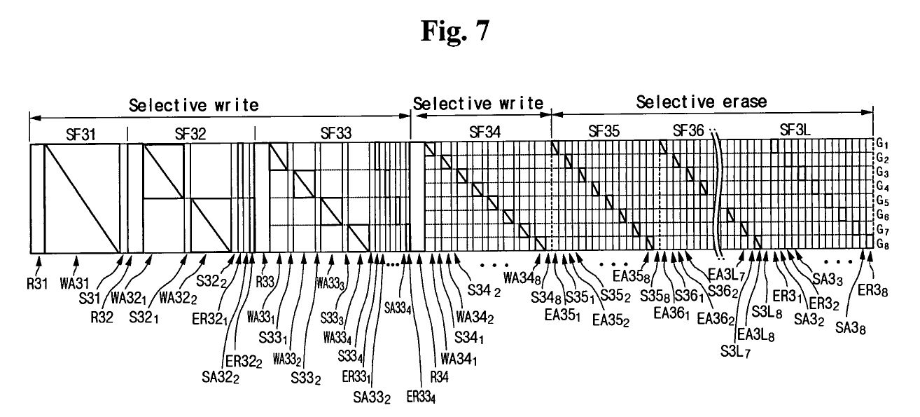

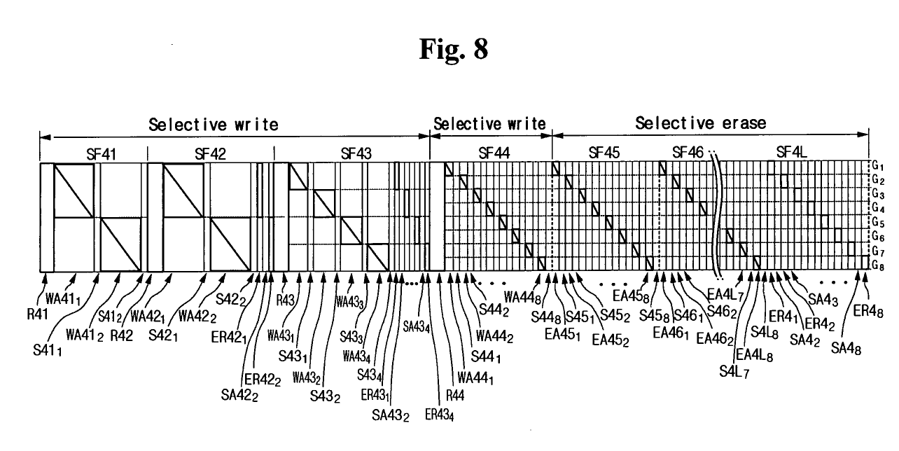

In the first exemplary embodiment of the present invention as described above, since all subfields have the same weight and gray scales are represented by the subfields successively lighted starting from the first subfield, there is a limited number of gray scales that the subfields can represent. Hereinafter, a method of increasing the number of gray scales that can be represented by the subfields will be described in detail with reference to FIG. 5, FIG. 6, FIG. 7 and FIG. 8.

First, a driving method of a plasma display according to a second exemplary embodiment of the present invention will be described with reference to FIG. 5 and FIG. 6.

FIG. 5 is a schematic diagram showing a PDP driving method according to the second exemplary embodiment of the present invention, and FIG. 6 is a diagram showing a gray scale representation in the driving method of FIG. 5.

As FIG. 5 shows, in the second exemplary embodiment of the present invention, the plurality of subfields SF21 to SF2L is grouped into two groups of subfields. The first group of subfields includes at least the first subfield of the subfields, and the second group of subfields includes the remaining subfields. FIG. 5 shows the first group of subfields including the first to third subfields SF21, SF22 and SF23 and the second group of subfields including the remaining subfields SF24 to SF2L. In the second exemplary embodiment, like the first exemplary embodiment, the plurality of row electrodes is divided into the plurality of row groups G₁ to G₈. Here, the first group of subfields SF21 to SF23 have respective weights, and gray scales are represented by a combination of the weights of the subfields SF21 to SF23. The second group of subfields SF24 to SF2L represent gray scales in the same manner as the subfields SF11 to SF1L described in the first exemplary embodiment.

For the plurality of row groups G₁ to G₈, the address periods of the selective write process are sequentially performed in the first group of subfields SF21 to SF23 and the sustain periods are performed after the address periods. Additionally, the subfields SF21, SF22 and SF23 begin with reset periods R21, R22 and R23, respectively. In the reset periods R21, R22, and R23, all discharge cells are initialized to be non-light-emitting cells and are set to a state where the selective write operation may be performed in the following address periods.

More specifically, a reset period R2k is performed in a k^{th} subfield SF2k of the first group subfields (where, according to the embodiment of FIG. 5, k is 1, 2 or 3). Next, select periods are sequentially performed for the first to eighth row groups G₁ to G₈. Light-emitting cells are selected from the discharge cells of the i^{th} row group Gᵢ through the write discharge in an address period WA2kᵢ of the select period for the i^{th} row group Gᵢ. Sustain discharge occurs in the discharge cells of the light-emitting cell state of the i^{th} row group Gᵢ, in a sustain period S2kᵢ of the select period for the i^{th} row group Gᵢ. Additionally, an erase operation is performed to erase the wall charges of the discharge cells of the i^{th} row group Gᵢ at the end of the sustain period S2kᵢ. Accordingly, the discharge cells set to the light-emitting cell state in the i^{th} row group Gᵢ emit light in the sustain period S2kᵢ of the select period for the i^{th} row group Gᵢ, but they do not emit light in a select period for the next row group Gᵢ₊₁. Therefore, since the discharge cells set to the light-emitting cell state in each row group Gᵢ emit light in only their own select periods, the weight of the k^{th} subfield SF2k of the first group corresponds to the length of the sustain period S2kᵢ of one row group.

Further, since the first group of subfields SF21 to SF23 has respective reset periods R21 to R23, discharge cells may be set to the light-emitting cell state irrespective of their state in previous subfields. Accordingly, in the first group of subfields SF21 to SF23, the sustain discharge may be selectively performed in each subfield for the discharge cells. Here, if the relative length (i.e., weight) of sustain periods S21ᵢ to S23ᵢ of the first to third subfields SF21 to SF23 is 1, 2 and 4, respectively, 8 gray scale levels (0 to 7) may be represented by the first group of subfields SF21 to SF23.

In order to perform the erase operation in the sustain period S2kᵢ of the first group of subfields SF21 to SF23, the last pulse of the sustain discharge pulses of the sustain period S2kᵢ may be narrower than the previous pulses so that wall charges are not formed. Alternatively, the wall charges formed by the sustain discharge may be erased by using a waveform that gradually changes voltages of the row electrodes after the last sustain discharge pulse.

Next, the subfields in the second group of subfields SF24 to SF2L has the same structure as the subfields SF11 to SF1L described in the first exemplary embodiment. That is, the address period and the sustain period are sequentially performed for the plurality of row groups G₁ to G₈.

Specifically, a first subfield SF24 of the second group of subfields has the reset period R24 like the subfield SF11 of the first exemplary embodiment, and the select period of each row group Gi includes the address period WA24ᵢ of the selective write process and the sustain period S24ᵢ. Additionally, the select period of each row group Gi in the remaining subfields SF25 to SF2L of the second group of subfields has the address periods EA25ᵢ to EA2Lᵢ of the selective erase process and the sustain period S25ᵢ to S2Lᵢ, like the select period for each row group Gi in the subfields SF12 to SF1L in the first exemplary embodiment. The last subfield SF2L has erase periods ER2₁ to ER2₈ and additional sustain periods SA₂ to SA₈ like the last subfield SF1L in the first exemplary embodiment. However, since the reset period R21 is performed in the first subfield SF21, the last erase period ER2₈ may be omitted.

Further, display periods, each of which is the sum of sustain periods of subfields in the second group of subfields, have the same length. Furthermore, the display periods are equal to the length of the sustain period S21ᵢ of the first subfield SF21 plus the sum of the lengths of the sustain periods S21ᵢ to S23ᵢ of the first group of subfields SF21 to SF23. That is, each subfield of the second group of subfields has a display period that may represent a gray scale level that is one more than the maximum gray scale level that may be represented by the first group of subfields SF21 to SF23. In this case, since the maximum gray scale level that may be represented by the sustain periods S21ᵢ to S23ᵢ of the first to third subfields SF21 to SF23 is 7 (=1+2+4), the display periods of the second group of subfields may represent a gray scale level of 8. Since the display period of the second group of subfields is eight times the sustain period S25i to S2Lᵢ of each row group, the length of the sustain period S25i to S2Lᵢ may be equal to the length of the sustain period of the first subfield S21ᵢ.

Thus, in the second group of subfields SF24 to SF2L, gray scales may be represented by the sum of display periods of successive subfields starting from the fourth subfield SF24. Further, gray scales within one field may be represented by the sum of gray scales represented in the first group of subfields SF21 to SF23 and gray scales represented in the second group of subfields SF24 to SF2L. Now, a method of such a gray scale representation will be described in detail with reference to FIG. 6.

In FIG. 6, “SW” represents that a discharge cell is set to the light-emitting cell state through the write discharge occurring in a corresponding subfield, and “SE” represents that a discharge cell is set to the non-light-emitting cell state through the erase discharge occurring in a corresponding subfield. Also, “◯” represents a discharge cell that maintains the light-emitting cell state in a corresponding subfield.

Referring to FIG. 6, gray scale levels of 0 to 7 are represented by a combination of subfields lighted in the first group of subfields SF21 to SF23. Additionally, gray scale levels that are multiples of 8 are represented by subfields successively lighted in the second group of subfields SF24 to SF2L, and gray scale levels that are greater than 8, but are not multiples of 8, are represented by a combination of the first group of subfields SF21 to SF23 and the second group of subfields SF24 to SF2L.

For example, a gray scale level of 8N (where N is an integer) is represented by the second group of subfields. That is, the gray scale level of 8N is represented when the non-light-emitting cell state is set through the erase discharge in an (N+1)^{th} subfield SF2(N+4) of the second group of subfields after the light-emitting cell state is set at the subfield SF24 through the write discharge. In this case, when the light-emitting cell state is also set at the first and third subfields SF21 and SF23, the gray scale level of 5 is represented in the first group of subfields. Accordingly, a total gray scale level of (8N+5) is represented in the first and second groups of subfields.

That is, in the second exemplary embodiment, when the second group of subfields SF24 to SF2L includes 31 total subfields and the first group of subfields SF21 to SF23 includes 3 total subfields, gray scale levels of 0 to 255 can be represented by a combination of the 34 total subfields. Accordingly, the number of subfields may be reduced as compared to the first exemplary embodiment.

Next, a driving method of a plasma display according to a third exemplary embodiment of the present invention will be described with reference to FIG. 7, which is a schematic diagram showing a driving method of a plasma display according to the third exemplary embodiment of the present invention.

In the driving method of the plasma display according to the third exemplary embodiment of the present invention, the plurality of subfields has the same structure as the second exemplary embodiment except the first group of subfields SF31 to SF33. In addition, in the first group of subfields SF31 to SF33, display periods are controlled by the number of row groups.

A structure and driving method of the second group of subfields SF34 to SF3L is the same as that of the second group of subfields SF24 to SF2L in the second exemplary embodiment. More specifically, a first subfield SF34 of the second group of subfields, which is the fourth subfield of all the subfields in FIG. 7, has a reset period R34, address periods WA34₁ to WA34₈ of the selective write process, and sustain periods S34₁ to S34₈ for each row group G₁ to G₈. Additionally, a k^{th} subfield SF3k in the second group of subfields has address periods EA3k₁ to EA3k₈ of the selective erase process and sustain periods S3k₁ to S3k₈ for each row group G₁ to G₈ (where, k is an integer from 5 to L). Additionally, the last subfield SF3L has erase periods ER3₁ to ER3₈ for each row group G₁ to G₈ and additional sustain periods SA3₂ to SA3₈ for each of the second to eighth row group G₂ to G₈.

As FIG. 7 shows, the number of row groups (4) in the third subfield SF33 of the first group of subfields SF31 to SF33 is ½ the number of row groups (8) in the second group of subfields SF34 to SF3L. Also, the number of row groups (2) in the second subfield SF32 is ¼ the number of row groups (8) in the second group of subfields SF34 to SF3L. Finally, the number of row groups (1) in the first subfield SF31 is ⅛ the number of row groups (8) in the second group of subfields SF34 to SF3L.

The first group of subfields SF31, SF32 and SF33 begin with reset periods R31, R32 and R33, respectively. In the reset periods R31, R32, and R33, all discharge cells are initialized to be non-light-emitting cells and are set to a state where the selective write operation may be performed in the following address periods. The address periods of the selective write process are sequentially performed for the row groups in the first group of subfields SF31 to SF33.

The reset period R31 is performed in the first subfield SF31 of the first group of subfields SF31 to SF33. Next, since the first subfield SF31 comprises one row group, the address period WA31 is performed for the plurality of row electrodes to thereby select light-emitting cells of the plurality of row electrodes. Next, the sustain period S31 is performed so that the sustain discharge occurs in discharge cells of the light-emitting cell state. In this case, the length of the sustain period S31 equals the length of the sustain period of the select period for one row group in the second group of subfields. That is, the brightness in the first subfield SF31 is ⅛ the brightness in a subfield of the second group of subfields.

Next, in the second and third subfields SF32 and SF33, the reset periods R32 and R33, respectively, are performed to initialize the state of the discharge cells, and then the select periods are sequentially performed for each row group. After the select periods of each row group ends, an erase period and additional sustain periods are sequentially performed.

Specifically, since the second subfield SF32 comprises a first row group G₁ to G₄ and a second row group G₅ to G₈, the address period WA32₁ and the sustain period S32₁ are performed for the first row group G₁ to G₄, and then the address period WA32₂ and the sustain period S32₂ are performed for the second row group G₅ to G₈. Next, the erase period ER32₁ is performed for the first row group G₁ to G₄, thereby setting the discharge cells of the first row group G₁ to G₄ to the non-light-emitting state, and then an additional sustain period SA32₂ is performed to thereby generate the sustain discharge in the second row group G₅ to G₈. Next, the erase period ER32₂ is performed to set the discharge cells of the second row group G₅ to G₈ to the non-light-emitting state. However, since the reset period R33 starts the third subfield SF33, the erase period ER32₂ may be omitted.

In this case, the length of each sustain period S32₁, S32₂ and SA32₂ equals the length of the sustain period of the select period for one row group in the second group of subfields. Hence, two sustain periods are performed for each row group in the second subfield SF32. Accordingly, the brightness in the second subfield SF32 is ¼ the brightness in a subfield of the second group of subfields.

Since the third subfield SF33 comprises four row groups (G₁ and G₂), (G₃ and G₄), (G₅ and G₆), and (G₇ and G₈), the select periods of the first to fourth groups of subfields are sequentially performed. That is, the address period WA33ᵢ and the sustain period S33ᵢ are performed for the i^{th} row group G₂ᵢ₋₁ to G₂ᵢ. Further, erase periods ER33₁, ER33₂, ER33₃, ER33₄ are sequentially performed for each row group (G₁ and G₂), (G₃ and G₄), (G₅ and G₆), and (G₇ and G₈), and additional sustain periods SA33₂, SA33₃, SA33₄ are inserted between the erase periods. Accordingly, four sustain periods are performed for each row group. However, since the reset period R34 is performed in the fourth subfield SF34, the last erase period ER32₄ may be omitted.

In this case, the length of each sustain period S33₁ to S33₄ and SA33₂ to SA33₄ equals the length of the sustain period of the select period for one row group in the second group of subfields. Hence, four sustain periods are performed for each row group in the third subfield SF33. Accordingly, the brightness in the third subfield SF33 is ½ of the brightness in a subfield in the second group of subfields.

Additionally, since the first group of subfields SF31, SF32 and SF33 has the reset periods R31, R32 and R33, respectively, like the second exemplary embodiment, discharge cells may be set to the light-emitting cell state irrespective of the their state in a previous subfield. In this case, assuming the weight of each subfield in the second group of subfields is 8, since the weights of the first to third subfields SF31 to SF33 are 1, 2 and 4, respectively, 8 gray scale levels (0 to 7) may be represented by a combination of the first group of subfields SF31 to SF33, like the second exemplary embodiment. Accordingly, in the third exemplary embodiment, like the second exemplary embodiment, when the second group of subfields SF34 to SF3L includes 31 total subfields and the first group of subfields SF31 to SF33 includes 3 total subfields, 256 gray scale levels (0 to 255) may be represented. Accordingly, the number of subfields may be reduced as compared to the first exemplary embodiment.

As described above, in the third exemplary embodiment of the present invention, the number of row groups determines the weights of the subfields. However, since there is one row group in the first subfield, the sustain discharge occurs after sequentially performing the selective write discharge for all row electrodes. In this case, for discharge cells of a row electrode for which the selective write discharge is performed early in the address period, since the sustain discharge does not occur until after performing the selective write discharge in other row electrodes, the sustain discharge may not smoothly occur due to loss of wall charges formed by the selective write discharge or loss of priming particles of the discharge cells.

Hereinafter, an exemplary embodiment where the sustain discharge may smoothly occur for row electrodes for which the selective write discharge is performed early in the address period will be described with reference to FIG. 8.

FIG. 8 is a schematic diagram showing a driving method of a plasma display according to a fourth exemplary embodiment of the present invention.

As shown in FIG. 8, in the driving method of the plasma display according to the fourth exemplary embodiment of the present invention, the plurality of subfields has the same structure as the third exemplary embodiment except for the first subfield SF41. That is, a structure and driving method of second and third subfields SF42 and SF43 of a first group of subfields and a second group of subfields SF44 and SF4L is the same as that of the second and third subfields SF32 and SF33 and the second group of subfields SF34 to SF3L of FIG. 7.

More specifically, for the first and second subfields SF41 and SF42, the plurality of row electrodes is divided into two row groups. The first subfield SF41 includes a reset period R41 to initialize the discharge cells. Light-emitting cells are set for a first row group G1 to G4 in an address period WA41, of the selective write process, and then sustain discharge occurs in the light-emitting cells of the first row group G₁ to G₄ in a sustain period S41. An erase operation for erasing wall charges of the discharge cells is performed at the end of the sustain period S41₁. Next, light-emitting cells are set for a second row group G₅ to G₈ in an address period WA41₂ of the selective write process, and then the sustain discharge occurs in the light-emitting cells of the second row group G₅ to G₈ in a sustain period S41₂. The erase operation for erasing wall charges of the discharge cells may be performed at the end of the sustain period S41₂. Alternatively, the erase operation may be omitted since a reset period R42 is performed in the next subfield SF42.

Additionally, reset periods R42 and R43, address periods WA42₁, WA42₂, WA43₁ to WA43₄, sustain periods S42₁, S42₂, SA42₂, S43, to S42₄, and SA43₂ to SA43₄, and erase periods ER42₁, ER42₂, ER43₁ to ER43₄ in the remaining subfields SF42 and SF43 of the first group of subfields are the same as reset periods R32 and R33, address periods WA32₁, WA32₂, WA33₁ to WA33₄, sustain periods S32₁, S32₂, SA32₂, S33₁ to S32₄, and SA33₂ to SA33₄, and erase periods ER32₁, ER32₂, ER33₁ to ER33₄ in the remaining subfields SF32 and SF33 of the first group of subfields in the third exemplary embodiment, respectively.

Further, a reset period R44, address periods WA44ᵢ and EA4kᵢ, sustain periods S4kᵢ and SA4kⱼ, and an erase period ER4Lᵢ in the second group of subfields SF44 to SF4L are the same as the reset period R34, the address periods WA33ᵢ and EA3kᵢ, the sustain periods S3kᵢ and SA3kⱼ, and the erase period ER3Lᵢ in the second group of subfields SF34 to SF3L in the third exemplary embodiment, respectively (where, k is an integer from 4 to L, i is an integer from 1 to 8, and j is an integer from 2 to 8).

In this manner, in the fourth exemplary embodiment, since half of the plurality of 5 row electrodes are first addressed and sustain-discharged in the first subfield SF41, an interval between the address period and the sustain period decreases, thus stably generating the sustain discharge using priming particles, as compared to the third exemplary embodiment.

In this way, the third and fourth exemplary embodiments differ in the grouping method of the row electrodes from the second exemplary embodiment. That is, in the third and fourth exemplary embodiments, the first group of subfields is divided into a group of subfields having minimal weights (the third group of subfields) and a group of the remaining subfields (the fourth group of subfields), and the row electrodes are grouped with the number of row electrodes corresponding to weights of relevant subfields in the fourth group of subfields. Similarly, in the third group of subfields, the row electrodes are grouped with the number of row electrodes is corresponding to weights of relevant subfields (the third exemplary embodiment), or with the more number row electrodes (the fourth exemplary embodiment).

Since detailed driving waveforms in the driving methods according to the second to fourth exemplary embodiments as described above may be easily known from the driving waveform of the first exemplary embodiment, detailed explanation thereof will be omitted. Additionally, the number of row groups and the number of subfields shown in the above exemplary embodiments may be modified in various ways.

As described above, according to exemplary embodiments of the present invention, since gray scales may be represented by the number of subfields successively lighted without using subfields having large weights, the problem of false contour may be overcome. Further, since the addressing operation is performed for each row group after the sustain period, priming particles produced during the sustain period may be used for the address discharge, thus reducing the width of the scan pulse. Moreover, since the width of the scan pulse may be further reduced by using the address period of the selective erase process, it is possible to achieve high speed scanning.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A driving method of dividing one field into a plurality of subfields and representing a gray scale using the plurality of subfields in a display device including a plurality of row electrodes, a plurality of column electrodes, and a plurality of discharge cells defined by the plurality of row electrodes and the plurality of column electrodes, the driving method comprising:
grouping the plurality of row electrodes into a plurality of row groups, dividing each subfield into a plurality of select periods respectively corresponding to the plurality of row groups, and grouping the plurality of subfields into a plurality of subfield groups;
in a select period for a first row group of a first group of subfields, selecting light-emitting cells from discharge cells of the first row group and setting the light-emitting cells of the first row group to non-light-emitting cells after sustain-discharging the light-emitting cells of the first row group during a sustain period;
in a select period for the first row group of a first subfield, which is positioned at the head in time, of a second group of subfields, selecting light-emitting cells from discharge cells of the first row group and sustain-discharging the light-emitting cells of the first row group during a sustain period; and
in a select period for the first row group of a second subfield of the second group of subfields, selecting non-light-emitting cells from the light-emitting cells of the first row group and sustain-discharging remaining light-emitting cells of the first row group during a sustain period.

2. The driving method of claim 1, further comprising:
in a select period for a second row group of the first group of subfields, selecting light-emitting cells from discharge cells of the second row group and setting the light-emitting cells of the second row group to non-light-emitting cells after sustain-discharging the light-emitting cells of the second row group during a sustain period;
in a select period for the second row group of the first subfield, selecting light-emitting cells from discharge cells of the second row group and sustain-discharging the light-emitting cells of the second row group during a sustain period; and
in a select period for the second row group of the second subfield, selecting non-light-emitting cells from the light emitting cells of the second row group and sustain-discharging remaining light-emitting cells of the second row group during a sustain period.

3. The driving method of claim 2, wherein, in the second group of subfields, light-emitting cells of the first row group are sustain-discharged during a sustain period of a select period for the second row group.

4. The driving method of claim 3, wherein, in the second group of subfields, a length of a sustain period of a select period for the first row group is equal to a length of the sustain period of the select period for the second row group.

5. The driving method of claim 1, wherein the first group of subfields includes a plurality of subfields having respective weights, and
wherein a gray scale level represented in the first group of subfields is determined by a sum of the respective weights of subfields in which a discharge cell is selected to be a light-emitting cell.

6. The driving method of claim 5, wherein, when the discharge cell is selected to be a light-emitting cell in the first subfield and then is selected to be a non-light-emitting cell in an n^{th} subfield of the second group of subfields, a gray scale level represented in the second group of subfields is determined by a sum of weights of (n−1) subfields of the second group of subfields.

7. The driving method of claim 6, wherein all subfields of the second group of subfields have the same weight.

8. The driving method of claim 7, wherein a total sum of weights of all subfields of the first group of subfields is one less than a weight of one subfield of the second group of subfields.

9. The driving method of claim 5, further comprising:
in a third subfield, which is a last subfield in time of the second group of subfields, setting light-emitting cells of the first row group to non-light-emitting cells after a specific period elapses.

10. The driving method of claim 9, wherein the specific period is a period during which sustain discharge for a period corresponding to a weight of a corresponding subfield of the first row group is completed.

11. The driving method of claim 9, wherein, after the light-emitting cells of the first row group are set to the non-light-emitting cells, a sustain period is performed for light-emitting cells of the second row group.

12. The driving method of claim 5, wherein the first group of subfields and the first subfield respectively include a reset period during which the plurality of discharge cells are initialized to be non-light-emitting cells.

13. A driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes, the driving method comprising:
grouping the plurality of subfields into a first group of subfields including a minimal weight subfield, a second group of subfields, and a third group of subfields including at least two consecutive subfields;
grouping the plurality of row electrodes into a plurality of row groups in the third group of subfields and grouping the plurality of row electrodes into a number of row groups corresponding to a weight of a subfield for each subfield in the second group of subfields;
dividing each subfield into a plurality of select periods respectively corresponding to the plurality of row groups in the second group of subfields and the third group of subfields;
selecting light-emitting cells from the plurality of row electrodes and discharging the light-emitting cells during a period corresponding to a weight of a corresponding subfield in the first group of subfields;
in a select period for a first row group of the second group of subfields, selecting light-emitting cells from discharge cells of the first row group and discharging the light-emitting cells of the first row group during a sustain period;
in a select period for a second row group of a first subfield, which is positioned at the head in time, of the third group of subfields, selecting light-emitting cells from discharge cells of the second row group and discharging the light-emitting cells of the second row group during a sustain period; and
in a select period for the second row group of a second subfield of the third group of subfields, selecting non-light-emitting cells from the light-emitting cells of the second row group and discharging remaining light-emitting cells of the second row group during a sustain period.

14. The driving method of claim 13, further comprising:
in a select period for a third row group of the second group of subfields, selecting light-emitting cells from discharge cells of the third row group and discharging the light-emitting cells of the third row group during a sustain period;
in a select period for a fourth row group of the first subfield, selecting light-emitting cells from discharge cells of the fourth row group and discharging the light-emitting cells of the fourth row group during a sustain period; and
in a select period for the fourth row group of the second subfield, selecting non-light-emitting cells from the light-emitting cells of the fourth row group and discharging remaining light-emitting cells of the fourth row group during a sustain period.

15. The driving method of claim 14, wherein, in the third group of subfields, light-emitting cells of the second row group are discharged during a sustain period of a select period for the fourth row group.

16. The driving method of claim 15, wherein, in the third group of subfields, a length of a sustain period of a select period for the second row group is equal to a length of the sustain period of the select period for the fourth row group.

17. The driving method of claim 15, further comprising:
in the second group of subfields, setting the light-emitting cells of the first row group to non-light-emitting cells after a specific period elapses.

18. The driving method of claim 17, wherein the specific period is a period during which sustain discharge for a period corresponding to a weight of a corresponding subfield of the first row group is completed.

19. The driving method of claim 17, wherein, after the light-emitting cells of the first row group are set to the non-light-emitting cells, a sustain period is performed for the light-emitting cells of the third row group.

20. The driving method of claim 13, wherein, in the minimal weight subfield, sustain discharge is performed after selecting light-emitting cells for all row electrodes.

21. The driving method of claim 13, wherein, in the minimal weight subfield, the plurality of row electrodes is grouped into at least two row groups, and
wherein discharging the light-emitting cells during the period corresponding to the weight of the corresponding subfield includes:
selecting light-emitting cells for a fifth row group of the at least two row groups and setting the light-emitting cells of the fifth row group to non-light-emitting cells after sustain-discharging the light-emitting cells of the fifth row group during a sustain period; and
selecting light-emitting cells for a sixth row group of the at least two row groups and setting the light-emitting cells of the sixth row group to non-light-emitting cells after sustain-discharging the light-emitting cells of the sixth row group during a sustain period.

22. The driving method of claim 13, wherein a gray scale level represented in the first group of subfields and the second group of subfields is determined by a sum of the weights of subfields in which a discharge cell is selected to be a light-emitting cell.

23. The driving method of claim 22, wherein, when the discharge cell is selected to be a light-emitting cell in the first subfield and then is selected to be a non-light-emitting cell in an n^{th} subfield of the third group of subfields, a gray scale level represented in the third group of subfields is determined by a sum of weights of (n−1) subfields of the third group of subfields.

24. The driving method of claim 23, wherein all subfields of the third group of subfields have the same weight.

25. The driving method of claim 24, wherein a total sum of weights of all subfields of the first group of subfields and the second group of subfields is one less than a weight of one subfield of the third group of subfields.

26. The driving method of claim 13, wherein the first group of subfields, the second group of subfields, and the first subfield respectively include a reset period during which the plurality of discharge cells are initialized to be non-light-emitting cells.

27. The driving method of claim 14, further comprising:
in a third subfield, which is a last subfield in time of the third group of subfields, setting light-emitting cells of the second row group to non-light-emitting cells after a specific period elapses.

28. The driving method of claim 27, wherein the specific period is a period during which sustain discharge for a period corresponding to a weight of a corresponding subfield of the second row group is completed.

29. The driving method of claim 27, wherein, after the light-emitting cells of the second row group are set to the non-light-emitting cells, a sustain period is performed for the light-emitting cells of the fourth row group.

30. A driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes, the driving method comprising:
grouping the plurality of row electrodes into a plurality of row groups, and grouping the plurality of subfields into a plurality of subfield groups;
sequentially setting light-emitting cells for each row group in each subfield of a first group of subfields;
setting the light-emitting cells of each row group to non-light-emitting cells after sustain-discharging the light-emitting cells during a first period between a period for setting the light-emitting cells of a row group and a period for setting light-emitting cells of a next row group, in each subfield of the first group of subfields;
sequentially setting light-emitting cells for each row group in each subfield of a second group of subfields; and
sustain-discharging the light-emitting cells during a second period between a period for setting the light-emitting cells of a row group and a period for setting light-emitting cells of a next row group, in each subfield of the second group of subfields.

31. The driving method of claim 30, wherein the first group of subfields performs a first type address discharge,
the second group of subfields includes a subfield for performing the first type address discharge and a subfield for performing a second type address discharge, and
a non-light-emitting cell is selected to be a light-emitting cell by the first type address discharge and the light-emitting cell is selected to be the non-light-emitting cell by the second type address discharge.

32. The driving method of claim 31, wherein the subfield for performing the first type address discharge in the second group of subfields is positioned at the head in time in the second group of subfields.

33. The driving method of claim 30, wherein the first group of subfields includes a plurality of subfields having respective weights, and
a length of the first period for each subfield of the first group of subfields corresponds to a weight of each subfield of the first group of subfields.

34. The driving method of claim 33, wherein the second period is repeated for each row group by a number of row groups in the second group of subfields.

35. A driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes, the driving method comprising:
in each subfield of a first group of subfields including a minimal weight subfield of the plurality of subfields, setting light-emitting cells in the plurality of row electrodes and sustain-discharging the light-emitting cells during a period corresponding to a weight of the corresponding subfield;
in each subfield of a second group of subfields of the plurality of subfields, grouping the plurality of row electrodes into a number of row groups corresponding to a weight of the corresponding subfield and sequentially setting light-emitting cells for each of the row groups;
in each subfield of the second group of subfields, sustain-discharging the light-emitting cells during a first period between a period for setting the light-emitting cells of a row group and a period for setting light-emitting cells of a next row group;
in each subfield of a third group of subfields of the plurality of subfields, grouping the plurality of row electrodes into a plurality of row groups and sequentially setting light-emitting cells for each of the row groups; and
in each subfield of the third group of subfields, sustain-discharging the light-emitting cells during a second period between a period for setting the light-emitting cells of a row group and a period for setting light-emitting cells of a next row group.

36. The driving method of claim 35, wherein the first group of subfields and the second group of subfields perform a first type address discharge,
the third group of subfields includes a subfield for performing the first type address discharge and a subfield for performing a second type address discharge, and
a non-light-emitting cell is selected to be a light-emitting cell by the first type address discharge and the light-emitting cell is selected to be the non-light-emitting cell by the second type address discharge.

37. The driving method of claim 36, wherein the subfield for performing the first type address discharge in the third group of subfields is positioned at the head in time in the third group of subfields.

38. The driving method of claim 35, wherein the first period is repeated for each row group by weights of the subfields in the second group of subfields, and
the second period is repeated for each row group by a number of the plurality of row groups in the third group of subfields.

39. A display device, comprising:
a display panel including a plurality of row electrodes, a plurality of column electrodes intersecting the plurality of row electrodes, and a plurality of discharge cells defined by the plurality of row electrodes and the plurality of column electrodes;
a driver for driving the display panel; and
a controller for controlling the driver such that one field is divided into a plurality of subfields to represent a gray scale,
wherein the controller:
groups the plurality of subfields into a plurality of subfield groups including a first group of subfields including a minimal weight subfield and a second group of subfields including at least two consecutive subfields,
controls the driver to set a non-light-emitting cell to a light-emitting cell through discharge in a first subfield in time of the first group of subfields and in a first subfield in time of the second group of subfields and
controls the driver to set a light-emitting cell to a non-light-emitting cell through discharge in remaining subfields of the second group of subfields.

40. The display device of claim 39, wherein the controller represents a gray scale level of a discharge cell as a sum of weights of subfields in which the discharge cell is set to a light-emitting cell state in the first group of subfields and a sum of weights of subfields from when the discharge cell is set to the light-emitting cell state to when the discharge cell is set to a non-light-emitting cell state in the second group of subfields.

41. The method of claim 1, wherein light-emitting cells and non-light emitting cells are selected through discharge.

42. A driving method of dividing one field into a plurality of subfields and representing a gray scale using the plurality of subfields in a display device including a plurality of row electrodes, a plurality of column electrodes intersecting the plurality of row electrodes, and a plurality of discharge cells defined by the plurality of row electrodes and the plurality of column electrodes, the driving method comprising:
grouping the plurality of subfields into a first group of subfields and a second group of subfields;
in the first group of subfields, turning on a discharge cell to be lit in a subfield irregardless of the discharge cell's previous on/off state in a previous subfield; and
in the second group of subfields, turning on a discharge cell to be lit only in a first subfield in time of the second group of subfields and turning off the discharge cell only in a subsequent subfield.
